(19) United States
(12) Patent Application Publication
(10) Pub. No.: US 2025/0086046 A1
(43) Pub. Date: Mar. 13, 2025

(54) FAULT DETECTION METHOD AND EQUIPMENT FOR DRAINAGE PIPE NETWORK, SERVER, AND STORAGE MEDIUM

(71) Applicant: ALIBABA CLOUD COMPUTING LTD., Zhejiang (CN)

(72) Inventors: Juan Xie, Wuxi, Jiangsu (CN); Yejun Wu, Wuxi, Jiangsu (CN)

(73) Assignee: HANGZHOU ALICLOUD FEITIAN INFORMATION TECHNOLOGY CO., LTD., Hangzhou, Zhejiang (CN)

(21) Appl. No.: 18/685,224

(22) PCT Filed: Nov. 8, 2022
(86) PCT No.: PCT/CN2022/130462

§ 371 Date: Feb. 20, 2024

(30) Foreign Application Priority Data
Dec. 15, 2021 (CN) 202111532983.X

(51) Int. Cl. G06F 11/07; G01F 23/80

(52) U.S. Cl. CPC G06F 11/079; G01F 23/804; G06F 11/0709

(57) ABSTRACT

A fault detection method and equipment for a drainage pipe network, a server, and a storage medium. In the fault detection method for the drainage pipe network, a liquid level time sequences of monitoring nodes in the drainage pipe network can be collected, and an abnormal event type of the current node may be identified according to the liquid level time sequences. After the abnormal event type is determined, a fault diagnosis algorithm corresponding to the abnormal event type can be adopted to perform hydraulic feature matching on the liquid level time sequence of the current node and the liquid level time sequence current node corresponding to a neighbor neighboring node, to obtain a fault diagnosis result corresponding to the current node.

### CROSS REFERENCE TO RELATED APPLICATIONS

This Application is a national stage filing under 35 U.S.C. § 371 of International Patent Application Serial No. PCT/CN2022/130462, filed Nov. 8, 2022, which claims priority to Chinese patent application No. 202111532983.X, filed Dec. 15, 2021. The entire contents of these applications are incorporated herein by reference in their entirety.

### TECHNICAL FIELD

The present application relates to a field of artificial intelligence technology, in particular, to a fault detection method and equipment for a drainage pipe network, a server, and a storage medium.

### BACKGROUND

With the acceleration of urbanization process and the increase in urban population and human activities, the operating loads on existing underground drainage pipe network systems of low design standards are increasing accordingly, and the probabilities of anomalies in drainage pipe networks are also increasing. Frequent anomalies in drainage pipe networks will lead to the problems regarding urban operation safety and environment. There is still a lack of an efficient method for identifying abnormalities in a drainage pipe network at present.

### SUMMARY

Embodiments of the present application provide a fault detection method and equipment for a drainage pipe network, a server, and a storage medium.

An embodiment of the present application provides a fault detection method for a drainage pipe network, including: acquiring a first liquid level time series collected at a current node in the drainage pipe network; performing abnormality type identification according to the first liquid level time series to obtain an abnormal event type of the current node; performing hydraulic characteristic matching on the first liquid level time series and a liquid level time series of a neighboring node of the current node by using a fault diagnosis algorithm corresponding to the abnormal event type to obtain a fault diagnosis result corresponding to the current node; the liquid level time series of the neighboring node including: a second liquid level time series corresponding to an upstream node of the current node, and/or a third liquid level time series corresponding to a downstream node of the current node.

An embodiment of the present application further provides a server, including a memory, a processor, and a communication component; the memory being configured for storing one or more computer instructions; the processor being configured for executing the one or more computer instructions to execute steps in the method provided in an embodiment of the present application.

An embodiment of the present application further provides a computer-readable storage medium stored with a computer program which, when executed, can implement steps in the method provided in an embodiment of the present application.

The foregoing summary is for purposes of illustration only and is not intended to be limiting in any way. In addition to the illustrative aspects, embodiments and features described above, further aspects, embodiments and features of the present application will be readily apparent by reference to the accompanying drawings and the following detailed description.

### BRIEF DESCRIPTION OF THE DRAWINGS

In the accompanying drawings, unless otherwise specified, the same reference numerals throughout the plurality of accompanying drawings indicate the same or similar components or elements. These accompanying drawings are not necessarily drawn to scale. It should be understood that these accompanying drawings depict only some of the embodiments disclosed in accordance with the present application and should not be considered as limiting the scope of the present application.

FIG. 1 is a schematic structural diagram of a fault detection system for a drainage pipe network provided in an embodiment of the present application.

FIG. 2 is a flow block diagram of a fault detection algorithm for a drainage pipe network provided in an embodiment of the present application.

FIG. 3 is a schematic flow diagram of a fault detection method for a drainage pipe network provided in an embodiment of the present application.

FIG. 4 is a schematic structural diagram of a server provided in an embodiment of the present application.

### DETAILED DESCRIPTION

In order to make the objects, technical solution and advantages of the embodiments of the present application clearer, the technical solution of the present application will be described clearly and completely below in conjunction with the embodiments and accompanying drawings in the present application. It is obvious that the described embodiments are only some of the embodiments of the present application, rather than all of them. Based on the embodiments of the present application, all other embodiments obtained by those skilled in the art without involving any creative efforts fall within the scope of protection of the present application.

With the acceleration of urbanization process and the increase in urban population and human activities, the operating loads on existing underground drainage pipe network systems of low design standards are increasing accordingly, and the probabilities of anomalies in drainage pipe networks are also increasing. Frequent anomalies in drainage pipe networks will lead to the problems regarding urban operation safety and environment. At present, troubleshooting, maintenance and so forth are performed manually only after problems arise in a drainage pipe network. One the one hand, this approach suffers from poor real-time performance, and has difficulty in dealing with pipe network problems over the wide range. On the other hand, it is also unable to reduce adverse impacts caused by faults in the drainage pipe network.

With regard to the above technical problem, some exemplary embodiments of the present application provide a solution to intelligently identify faults in a drainage pipe network, thereby improving the operation and maintenance efficiency of the pipe network. The solution will be illustrated in a detailed manner in conjunction with the accompanying drawings below.

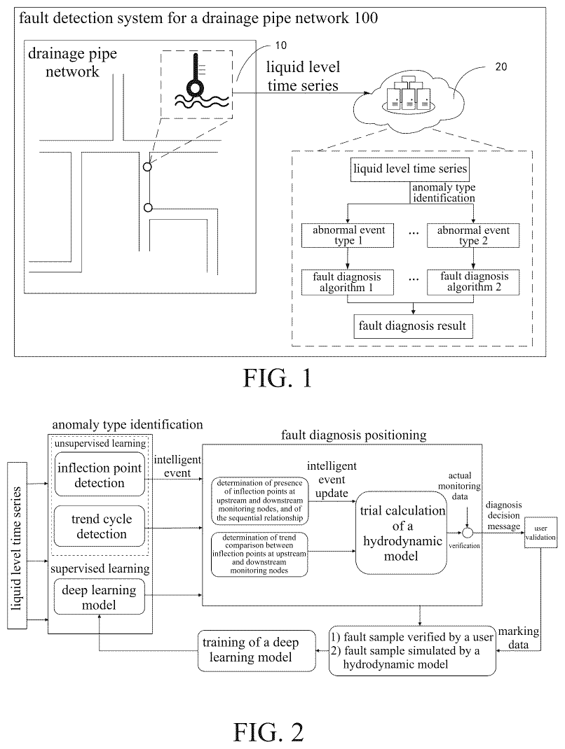

FIG. 1 is a schematic structural diagram of a fault detection system for a drainage pipe network provided in an embodiment of the present application. As shown in FIG. 1, a fault detection system 100 for a drainage pipe network mainly includes: an IoT device (IoT device) 10 and a server 20. The number of IoT devices 10 may be a plurality and may be installed at a plurality of nodes to be monitored (i.e., monitoring nodes) in the drainage pipe network. One or more IoT devices may be mounted at each monitoring node.

The IoT device 10 may be implemented as a liquid level sensor for detecting a liquid level, including but not limited to at least one of a contact liquid level sensor (e.g., pressure sensor) and a non-contact liquid level sensor (ultrasonic level transmitter, radar level transmitter), and a dual-probe hybrid sensor (pressure+ultrasound), to which no limitation is made in the embodiment.

In the embodiment, the IoT device 10 are mainly used to collect liquid level data of a monitoring node where it is located, and upload it to the server 20 via the IoT. The IoT devices 10 may collect liquid level data of a node according to a set collection frequency, and may also collect liquid level data when a change in the liquid level of the node exceeds a specified range, to which no limitation is made in the embodiment.

The server 20 may be implemented as a conventional server device or cloud server device, to which no limitation is made in the embodiment. In some embodiments, for facilitating distributed calculation, the server 20 may be implemented as a cloud server located on a cloud platform. The drainage pipe fault detection algorithm may be deployed in a containerized manner on the basis of the cloud server, thereby implementing distributed parallel calculation.

In the embodiment, the server 20 is mainly used to receive liquid level data sent by an IoT device 10, and detecting a faulty state of the drainage pipe network according to the received liquid level data.

In some embodiments, after receiving liquid level data sent by an IoT device 10, in order to facilitate subsequent calculation, the server 20 may perform preprocessing operations such as data cleaning, filtering and the like on the received liquid level data, thereby obtaining a standardized liquid level time series. A liquid level time series refers to a number sequence obtained by arranging liquid level values in the order of their corresponding detection time. At each time of fault detection, the server 20 may use a sliding window to select the liquid level time series within a part of the time period from the preprocessed liquid level time series to participate in the calculation.

The drainage pipe network includes a plurality of nodes to be monitored. The server 20 may detect a faulty state of each node according to the liquid level time series collected at each node. In the following, any one of the nodes to be monitored (i.e., a current node below) is taken as an example for exemplary illustration.

Taking the current node as an example, an IoT device mounted at the current node may collect a liquid level time series of the current node. In order to facilitate description and distinction, the liquid level time series of the current node is described as a first liquid level time series.

The server 20 may perform abnormality type identification according to the first liquid level time series after acquiring the first liquid level time series of the current node in the drainage pipe network, to obtain an abnormal event type of the current node. The abnormal event refers to an unknown event in an abnormal state, and may be deemed as a suspected fault. There may be various types of abnormal events in the drainage pipe network, e.g., suspected blockage type, suspected sudden blockage type, suspected water leaking type, and the like. In the embodiment, an abnormal event type is used to describe the identified abnormal event type.

When performing abnormality type identification according to the liquid level time series, the server 20 may perform abnormality type identification on the basis of an unsupervised learning algorithm, and may also perform abnormality type identification on the basis of a supervised learning algorithm, to which no limitation is made in the embodiment.

When the server 20 identifies an abnormal event type of a current node, it may be deemed that there is such a type of suspected fault at the current node. For further diagnosing the suspected fault, the server 20 may perform hydraulic characteristic matching on the first liquid level time series and a liquid level time series of a neighboring node of the current node by using a fault diagnosis algorithm corresponding to the abnormal event type to obtain a fault diagnosis result corresponding to the current node. The liquid level time series of the neighboring node including: a second liquid level time series corresponding to an upstream node of the current node, and/or a third liquid level time series corresponding to a downstream node of the current node.

For example, as shown in FIG. 1, after abnormality type identification is performed according to the liquid level time series, if an abnormal event type 1 is identified, a fault diagnosis algorithm 1 is applied for further fault diagnosis. If an abnormal event type 2 is identified, a fault diagnosis algorithm 2 may be applied for further fault diagnosis.

In the embodiment, an abnormal event type may correspond to one or more fault diagnosis algorithms, and a plurality of abnormal event types may also correspond to a fault diagnosis algorithm, to which no limitation is made in the embodiment. A fault diagnosis algorithm is used to perform fault diagnosis according to the hydraulic characteristics at the upstream and downstream nodes. The hydraulic characteristics may include hydraulic flow characteristics, flow velocity characteristics, liquid level height characteristics and the like at the upstream and downstream nodes, to which no limitation is made in the embodiment. When different types of faults occur at the current node, the hydraulic characteristics of the current node will be distinctly different from that of the upstream and downstream nodes, and satisfy a preset condition. In subsequent embodiments, optional embodiments of fault diagnosis based on hydraulic characteristics will be further described, to which no more details will be repeated here.

The fault diagnosis result of the current node output by the fault diagnosis algorithm may include: there is a type of fault between the current node and a downstream node thereof, or there is no fault between the current node and the downstream node thereof. If there is a type of fault between the current node and the downstream node thereof, a fault warning prompt may be provided to facilitate timely operation, maintenance, and management.

In the embodiment, a liquid level time series of a monitoring node in the drainage pipe network may be collected, and an abnormal event type of the current node may be identified according to the liquid level time series. After the abnormal event type is determined, hydraulic characteristic matching may be performed on the liquid level time series of the current node and a liquid level time series corresponding to a neighboring node by using a fault diagnosis algorithm corresponding to the abnormal event type, to obtain a fault diagnosis result of the current node. Based on this implementation, fault detection may be intelligently performed of a node to be monitored in the drainage pipe network, reducing reliance on manpower, and facilitating efficient and accurate fault detection of the drainage network, thereby facilitating assisting the operation and maintenance of the drainage network.

In the aforesaid and following respective embodiments of the present application, the blockage mode of the drainage pipe network, after being analyzed, may be at least classified into a sudden blockage mode and long-term blockage modes at different levels. The sudden blockage mode may include a sudden pipe blockage caused by non-disposable items (e.g., wet tissues, baby diapers, cardboards and the like) entering the pipelines. The long-term blockage modes may include long-term pipe blockages formed by the accumulation of greases or other sediments in sewers over time. The long-term blockage modes have different blockage levels which may be classified according to the blockage degree of pipe diameters by accumulated sediments. For example, when 20% of a pipe diameter is clogged by the sediments, this may be classified as a first-level blockage degree; when 40% of the pipe diameter is clogged by the sediments, this may be classified as third-level blockage degree; when 60% of the pipe diameter is clogged by the sediments, this may be classified as fifth-level blockage/blockage degree, to which no more details will be repeated here.

In the embodiment, at least a sudden pipe blockage type of abnormal event and long-term blockage type of abnormal events at different levels may be identified when abnormality type identification is performed according to the liquid level time series. This will be illustrated exemplarily in the following in connection with FIG. 2 and different embodiments.

In some optional embodiments A1, when performing abnormality type identification according to the first liquid level time series of the current node to obtain an abnormal event type of the current node, the server 20 may perform inflection point detection on the first liquid level time series. The liquid level time series includes a plurality of liquid level values which are arranged according to corresponding collection times to form a liquid level time series. An inflection point refers to a liquid level value in the liquid level time series that changes the rising direction or falling direction of a time series. If an inflection point is detected from the first liquid level time series, the abnormal event type corresponding to the current node is determined as a sudden pipe blockage type. That is, when the variation trend of liquid level values at the current node suddenly rises or suddenly falls, it may be deemed that a sudden pipe blockage may possibly occur at the current node.

In some implementations, performing inflection point detection on the first liquid level time series includes: dividing the first liquid level time series into a plurality of subsequences, and calculating a loss function of the first liquid level time series and respective loss functions of the plurality of subsequences. The loss function of each sequence may be calculated through loss functions such as DTW (Dynamic Time Warping), soft-DTW, and relative entropy, which are included but not limited in the embodiment.

Next, a signal difference between the plurality of subsequences may be calculated according to a difference value between the loss function of the first liquid level time series and the respective loss functions of the plurality of subsequences. If the signal difference of the subsequences is greater than a set penalty value, it is determined that there is an inflection point in the first liquid level time series. The penalty value is any empirical value greater than 0, and may be set according to actual requirements, to which no limitation is made in the embodiment. Further exemplary illustrations are made below.

Assuming that the first liquid level time series is y_{a..b}, subsequence division is performed on y_{a..b} to obtain two subsequences, i.e., y_{a..t} and y_{t..b}. The loss functions c of y_{a..b}, y_{a..t}, and y_{t..b} are calculated, respectively, to obtain c(y_{a..b}), c(y_{a..t}), c(y_{t..b}). The signal difference d(y_{a.t},y_{t..b}) between a plurality of subsequences may be expressed as follows: d(y_{a.t},y_{t..b})=c(y_{a..b})−c(y_{a..t})−c(y_{t..b}), where 1≤a<t<b<T. If d(y_{a.t}, y_{t..b}) is greater than a set penalty value, it is determined that there is an inflection point in y_{a..b}.

Based on a manner of performing inflection point detection on a liquid level time series provided in the embodiment, it can be preliminarily determined whether there is a suspected sudden blockage fault at the current node according to the liquid level time series detected at the current node, and data support may be provided for subsequent fault diagnosis.

In some optional embodiments A2, when performing abnormality type identification on the first liquid level time series to obtain the abnormal event type of the current node, the server 20 may perform trend cycle detection on the first liquid level time series. When performing trend cycle detection, time series decomposition can be performed on the first liquid level time series to obtain a liquid level trend at the current node. If the liquid level trend of the current node presents a continuous rising trend, it is determined that the abnormal event type of the current node as a long-term blockage type.

Time series decomposition refers to decomposition of different components from the liquid level time series. It may be known from the analysis of the liquid level changes in pipes that the liquid level changes in pipes are affected by cyclical factors such as season and tide, and are also affected by input factors such as rainwater. Thus, the liquid level time series {yₜ} may be regarded as an additive model (additive decomposition). The model expression of y(t) may be as follows:

$${y}_{t} = {τ}_{t} + {\sum }_{i = 1}^{m} {S}_{i , t} + {r}_{t} \qquad t = 0 , 1 , … N - 1 ,$$

where S_{i,t} represents the iₜₕ periodic component (seasonal component); i=1, 2, . . . m; m is a positive integer; τₜ is a trend-cycle component; rₜ is a remainder component.

Based on the above model expression, a periodic component, a remainder component, and a trend-cycle component in the liquid level time series may be decomposed upon time series decomposition is performed on the liquid level time series, such that the trend-cycle component may be used to identify the state of a pipe on the premise that the effects of the periodic component and remainder component on the process of determining the liquid level trend are reduced.

In the embodiment, when a long-term abnormal blockage in the drainage pipe network is identified, the historical liquid level data at each node for a long time may be analyzed. When time series decomposition is performed on a great amount of historical liquid level data, the decomposition process may include: iterative decomposition of an inner loop and an outer loop with the decomposition manner of embedding the outer loop with the inner loop. The outer loop decomposition is mainly used to calculate a remainder component rₜ, and adjust the weight of the remainder component rₜ. When the weight of the remainder component rₜ is adjusted, the weight of the remainder component rₜ may be updated by using a quadratic function so as to reduce the effects of an outlier in the liquid level time series on the result of inner loop decomposition. The inner loop decomposition is mainly used to calculate trend fitting and periodic components. In the process of the inner loop, the remainder weight generated by the outer loop decomposition can be used to obtain the periodic component S_{i,t} and the trend-cycle component rₜ through locally weighted regression and a low-pass filtering algorithm. When the outer loop is ended, the periodic component S_{i,t} and the trend-cycle component rₜ converged after iterative decomposition may be output, and it may be determined whether there is a long-term abnormality at a node by detecting whether the converged trend-cycle component rₜ rises.

In some implementations, after determining the abnormal event type of the current node as the long-term blockage type, the server 20 may also determine a blockage level corresponding to the current node according to a ratio of an amount of change in the rising trend of a liquid level of the current node to a pipe diameter. The blockage level is used to represent the blockage degree of a pipe. The blockage degree may be different fuzzy scales divided from 0% to 100%. For example, a fault diagnosis result output by the server 20 may be: a long-term blockage event is detected, the blockage severity is 50% of the pipe diameter.

Based on the manner of time series decomposition of the liquid level time series provided in the embodiment, it is possible to preliminarily determine whether there is a suspected long-term blockage fault at the current node according to the liquid level time series detected at the current node, and data support may be provided for subsequent fault diagnosis.

The above-mentioned Embodiments A1 and Embodiments A2 describe optional implementations of adopting an unsupervised algorithm for identifying the abnormal event types. In addition to the unsupervised above algorithm, the embodiments of the present application further provide an optional implementation for identifying abnormal event types on the basis of a supervised algorithm, which will be illustrated exemplarily in the following in conjunction with Example A3.

In some optional Embodiments A3, when performing the abnormality type identification according to the first liquid level time series to obtain the abnormal event type of the current node, the server 20 may input the first liquid level time series and the third liquid level time series into a deep learning model. Based on the deep learning model, feature extraction on be performed on the first liquid level time series and the third liquid level time series, and a probability that a pipe between the current node and a downstream node thereof belongs to at least one abnormal event type can be calculated according to the extracted feature. After the probability that the pipe between the current node and the downstream node thereof belongs to at least one abnormal event type is calculated, an abnormal event type of the current node may be output according to the probability that the pipe between the current node and the downstream node thereof belongs to at least one abnormal event type.

In the embodiment, the at least one abnormal event type includes at least one of: a sudden blockage event and long-term blockage events at different levels. The deep learning model may be implemented as a classification model for classifying input data into at least one type.

In some implementations, the deep learning model may include but not limited to models such as ResNet, EfficientNet, RegNet, ResNeSt, SKNet, ECAResNet and NFNet or models after the above models are deformed, to which no limitation is made in the embodiment.

In some implementations, the deep learning model may calculate, according to the features learned from the first liquid level time series and the third liquid level time series, a probability that the first liquid level time series and the third liquid level time series belong to a sudden blockage abnormality and a probability that they belong to long-term blockage anomalies at different levels. If the probability of the sudden blockage abnormality is greater than a set probability threshold, the abnormal event type of the current node is output as a sudden blockage event. If the probability of a long-term blockage abnormality of a certain level is greater than a set probability threshold, the abnormal event type of the current node output is a long-term blockage event at a certain level.

The deep learning model provided in the embodiment may be obtained on the basis of a great amount of sample data, which will be illustrated exemplarily below.

In some implementations, the server 20 may acquire a liquid level sequence sample marked with a corresponding abnormality type true value (Ground Truth). The liquid level sequence sample includes: a plurality of sets of liquid level trend comparison data of neighboring upstream and downstream nodes.

In the embodiment, the liquid level sequence sample may be acquired by monitoring liquid level data of the drainage pipe network, or may be obtained through simulation of a hydrodynamic model of the drainage pipe network.

In some embodiments, liquid level time series collected by an IoT device 10 may be accumulated continuously as a part of the liquid level sequence sample in the process of performing abnormal event type identification in the preceding Embodiments A1 and Embodiments A2. Meanwhile, a hydrodynamic model of the drainage pipe network is used to simulation the fault of the drainage pipe network, and the liquid levels in the state of fault simulation are sampled to obtain a liquid level time series as another part of the liquid level sequence sample. The above two types of samples may be mutually supplemented, providing data support for training of a deep learning model.

For the deep learning model, at the initial stage of putting it into use, due to insufficient training samples, the classification function of the deep learning model will be subject to certain limitations. In some optional embodiments, the process of identifying abnormal event types may be divided into at least two stages in terms of time dimension: the first stage of identification based on an unsupervised algorithm and the second stage of identification based on a supervised algorithm. As such, the requirements for model identification may be satisfied, and samples may be accumulated when the performance of the deep learning model does not meet the requirements.

In the first stage, a liquid level time series of any node may be identified on the basis of the preceding Embodiments A1 and Embodiments A2. After obtaining an identification result, the server 20 may send the identification result and the liquid level time series of a node to a user's terminal device so that the user can confirm the identification result. If the user confirms that the identification result matches the real fault condition of the node, the server 20 may automatically mark the liquid level time series of the node according to the identification result. If the user confirms that the identification result does not match the real fault condition of the node, the user may manually mark the liquid level time series of the node, thereby obtaining a more authentic and reliable liquid level sequence sample (i.e., a fault sample confirmed by user illustrated in FIG. 2). Exemplarily, when a liquid level sequence sample is marked, long-term blockage labels may be divided into a plurality of long-term blockage labels with different blockage levels, and labels indicating long-term blockage abnormality with different levels may be added on the liquid level sequence sample according to the actual blockage condition corresponding to the liquid level sequence sample. Accordingly, the deep learning model may learn the liquid level distribution characteristics of a pipe with different levels of long-term blockage, and learn the capability of classifying long-term blockage types with different levels.

While the first stage is being executed, the server 20 may simulate a fault of a node on the basis of a hydrodynamic model of the drainage pipe network, and collect liquid level data in a faulty state so as to generate a liquid level time series sample. The liquid level time series sample generated by the hydrodynamic model may be automatically marked by the server 20 according to fault level parameters used in the fault simulation to obtain a fault sample simulated by the hydrodynamic model as illustrated in FIG. 2. For example, when performing simulation of a first-level long-term blockage fault on water pipe P1 in the drainage pipe network through a hydrodynamic model, the server 20 may sample liquid level data of the water pipe P1 in a simulated faulty state to obtain the liquid level time series of the water pipe P1, and may add a first-level long-term blockage label on the liquid level time sequence of the water pipe P1.

Based on sample data accumulated at the first stage, simulated by the first-level hydrodynamic model, the server 20 may train a deep learning model, and execute an identification task at the second stage on the basis of the trained deep learning model.

In the process of training, the server 20 may perform feature extraction on the liquid level sequence sample through a deep learning model to obtain a sample feature, and perform abnormality prediction according to the sample feature and a parameter of the deep learning model to obtain an abnormality type prediction result corresponding to the liquid level sequence sample. Next, the deep learning model may be trained according to an error between the abnormality type prediction result and the abnormality type true value marked on the liquid level sequence sample until the error converges to a specified range.

Taking implementation of the deep learning model as ResNet as an example, the training process of ResNet may be expressed by the formulas below:

$$\begin{matrix}{a}^{l + 1} = Activate ( {w}^{l + 1} {a}^{l} + {b}^{l + 1} ) \\ {a}^{′} = {w}^{l + 2} Activate ( {w}^{l + 1} {a}^{l + 1} + {b}^{l + 1} ) + {b}^{l + 2} \\ {a}^{s} = Soft\_Thresholding ( {a}^{′} , α ) \\ {a}^{l + 2} = {a}^{s} + F ( {a}^{l} ) ,\end{matrix}$$

where w and b are a weight component and an offset component of each layer of a network in ResNet; a^{l}, a^{l+1}, a′, and a^{l+2} are input of ResNet, output of a first hidden layer, output of a second hidden layer, respectively; a^{s} is a soft-thresholding structure after calculated by a soft threshold function (Soft-Thresholding) which is used to flexibly set a feature value interval; F(a^{l}) is a residual term added with respect to CNN (Convolutional Neural Networks) for reducing sample feature losses in the process of multi-layer training, and performing noise reduction on time series data so as to cope with the uncertain disturbance in the drainage pipe network and improve the capability for learning features.

With continuous fault diagnosis, the amount of the liquid level sequence samples will be constantly increasing, and the classification accuracy of the deep learning model will be improved accordingly. In the process of training, sample data may be divided into a training set and a test set, and cross validation may be performed by using a prediction result in the training set and a training result in the test set. After the loss of the deep learning model is converged to a specified range, a result model obtained by training may be output, and a second stage of identification operation of abnormal event type may be performed on the basis of the result model.

In the embodiment described above, when sample data are insufficient, an unsupervised learning algorithm is used to identify an abnormal event type, and sample data for training the deep learning model are synchronously accumulated. It can satisfy the identification needs of abnormal events at the initial stage of monitoring, and improve the identification accuracy of abnormal events through continuous accumulation and learning.

On the basis of the respective embodiments described above, after determining an abnormal event type at the current node, the server 20 may perform hydraulic characteristic matching on the first liquid level time series and a liquid level time series corresponding to a neighboring node of the current node by using a fault diagnosis algorithm corresponding to the abnormal event type.

Further exemplary illustrations will be provided below in conjunction with FIG. 2 and different abnormal event types.

In some optional embodiments B1, if an abnormal event of the current node is a sudden blockage event, the server 20 may perform a determination on presence of an inflection point of upstream and downstream monitoring nodes and a determination on the sequential relationship.

In some implementations, if the abnormal event type of the current node is a sudden blockage event, the server 20 may determine whether there is an inflection point in the second liquid level time series and the third liquid level time series. If there is no inflection point in the second liquid level time series and the third liquid level time series, it is then determined the fault diagnosis result of the current node is that there is a sudden blockage fault in the pipe between the current node and the downstream node.

If there is an inflection point in the second liquid level time series while there is no inflection point in the third liquid level time series, the server 20 may compare whether an appearance moment of the inflection point of the second liquid level time series is later than the appearance moment of the inflection point of the first liquid level time series. If the appearance moment of the inflection point in the second liquid level time series is later than the appearance moment of the inflection point in the first liquid level time series, it is then determined the fault diagnosis result corresponding to the current node is that there is a sudden blockage fault in the pipe between the current node and the downstream node.

In some embodiments, if the appearance moment of the inflection point in the second liquid level time series is earlier than the appearance moment of the inflection point in the first liquid level time series, it may be determined that the fault diagnosis result of the current node is that there is no abnormality, and an abnormality may possibly occur at an upstream node.

In some optional embodiments B2, if an abnormal event of the current node is a long-term blockage event, the server 20 may perform a trend comparison determination operation on the current node and a downstream monitoring node thereof.

In some implementations, if an abnormal event type of the current node is a long-term blockage event, the server 20 may perform trend comparison on the first liquid level time series and the third liquid level time series. If a liquid level in the first liquid level time series presents a rising trend and a liquid level in the third liquid level time series has no rising trend, it is then determined that the fault diagnosis result of the current node is that there is a long-term blockage fault in the pipe between the current node and the downstream node.

As shown in FIG. 2, the server 20 may include an abnormality type identification module and a fault diagnosis and positioning module. When identifying an abnormal event type, the abnormality type identification module may send to the fault diagnosis and positioning module an intelligent event, e.g., a suspected sudden blockage event or a suspected long-term blockage event of a certain level.

The fault diagnosis and positioning module may use different determination methods described above for fault diagnosis according to an abnormal event type corresponding to the intelligent event. After determining the diagnosis result based on the diagnosis process disclosed in the above embodiments, the fault diagnosis and positioning module may update the intelligent event sent by the abnormality type identification module. For example, if determining that there is no sudden blockage fault at the current node through the above diagnosis, the fault diagnosis and positioning module may update the state of a suspected sudden blockage event identified by the abnormality type identification module to a cancelled state. If diagnosing that there is a sudden blockage fault at the current node, the fault diagnosis and positioning module may update the state of the suspected sudden blockage event identified by the abnormality type identification module to a confirmed state.

For example, if determining that there is no long-term blockage fault of a certain level at the current node through the diagnosis above, the fault diagnosis and positioning module may update the state of a suspected long-term blockage event of a certain level identified by the abnormality type identification module to a cancelled state. If diagnosing that there is a long-term blockage fault of a certain level at the current node, the fault diagnosis and positioning module may update the state of the suspected long-term blockage event of a certain level identified by the abnormality type identification module to a confirmed state.

In some implementations, when the state of an intelligent event is a confirmed state, the server 20 may further output the intelligent event in a set manner. For example, a prompt message indicating that a sudden blockage event or a long-term blockage event of a certain level has been detected may be sent to a user's terminal device or other IoT devices (e.g., abnormal siren) to prompt the user to perform operation and maintenance.

On the basis of the respective embodiments above, the server 20 may further perform fault positioning after obtaining a fault diagnosis result of the current node. The fault positioning refers to positioning of a faulty pipe or positioning of a faulty section of a pipe in pipes between the current node and a downstream node thereof.

In some implementations, if determining that there is a long-term blockage fault or sudden blockage faut in a pipe between the current node and a downstream node thereof, the server 20 may perform a fault assumption calculation on the pipe between the current node and the downstream node thereof through a hydrodynamic model corresponding to the pipe between the current node and the downstream node thereof, to determine a faulty pipe between the current node and the downstream node thereof.

The hydrodynamic model is obtained by modeling the physical structure of the drainage pipe network, and is used for simulating the hydrodynamics in the drainage pipe network. The hydrodynamic model may be described by the mass and momentum equations for the unsteady free surface flow of a pipe, as shown in the following equations:

$$\begin{matrix}\frac{\partial A}{\partial t} + \frac{\partial Q}{\partial x} = 0 \\ \frac{\partial Q}{\partial t} + \frac{\partial ( {Q}^{2} / A )}{\partial x} + g A \frac{\partial H}{\partial x} + {gAS}_{f} = 0 ,\end{matrix}$$

where A is the cross-section flow area of a pipe; Q is an amount of water flow of the pipe; H indicates head (mechanical energy per unit weight of liquid); g indicates gravitational acceleration; S_{f} indicates a friction slope; x indicates a distance; Y_{btm} indicates a pipe filling depth. When fault simulation is performed on any pipe, a fault level may be set by setting the Y_{btm} value. When there is a large Y_{btm} value, the pipe has a great filling depth, and has a high blockage fault level. When there is a small Y_{btm} value, the pipe has a small filling depth, and has a low blockage fault level.

Based on the above hydrodynamic model, after it is determined that there is a fault in a pipe between the current node and a downstream node thereof, the fault degree of each pipe may be hypothesized by setting Y_{btm} within the scope of the pipe corresponding to the current node and the downstream pipe thereof, and liquid level data of the pipe under fault may be output by using a hydrodynamic model. By verifying liquid level data output by the hydrodynamic model and the actual monitoring data of the liquid level collected by the IoT in the pipe, it can be determined whether the assumption on the pipeline is correct. The verification manner may include likelihood comparison, trend comparison, and so forth. If a simulated liquid level data output under an assumed fault and an actual monitoring data of the liquid level collected by an IoT device do not satisfy a set similarity condition, it may be considered that the assumption is not correct. If a simulated liquid level data and an actual monitoring data satisfy a set similarity condition, it may be considered that the assumption is correct.

If the assumption is incorrect, the assumed fault level may be modified by adjusting Y_{btm}, and trial simulation may be continued until the similarity between the simulated liquid level monitoring data output under the assumed fault and the actual monitoring data of the liquid level collected by an IoT device satisfies a set similarity condition.

When the assumption is correct, it may be determined that a pipe where fault simulation is performed is a pipe where the current node fails, and a fault level may be determined according to the Y_{btm} parameter. A pipe where the current node fails may include one pipe or a plurality of pipes. For example, in some embodiments, the fault positioning result output by a hydrodynamic model is: the blockage positions are on pipe P1 and pipe P2 between the upstream node D1 and the downstream node D2, where the blockage level of the pipe P1 is level 2, and the blockage level of the pipe P2 is level 5.

It should be noted that the way of fault assumption based on the hydrodynamic model and thus locating the fault location is computationally intensive. For example, there are 20 pipes within the range of the current node, 10 blockage levels are set for each pipe. During fault assumption calculation, each pipe has 10 assumption scenarios, and there will be 200 assumption scenarios to be calculated for 20 pipes. If the calculation time for each assumption scenario is 1 minute, it will take 200 minutes to calculate, the real-time performance is poor.

In order to improve the efficiency of fault assumption calculation and control the calculation cost, in the embodiment, a distributed calculation approach may be adopted to execute the fault assumption calculation in parallel, thereby reducing the time consumed as required in the fault assumption calculation. Exemplarily, the server 20 may be implemented as one or more cloud servers provided on a cloud platform. A plurality of dockers may be operated on each cloud server. A hydrodynamic model may be deployed for each docker. When fault assumption calculation is performed on the basis of a hydrodynamic model, a plurality of dockers which are idle or have a low load pressure may be selected on the cloud platform to perform distributed parallel calculation on a plurality of assumption scenarios, so as to quickly obtain a fault assumption result. A center manager component for fault diagnosis and an agent component (agent) for acquiring liquid level data of a monitoring node may be operated in an identical docker, and may also be operated in different dockers, to which no limitation is made in the embodiment.

On the basis of the above embodiment, after it is diagnosed that there is a fault at a monitoring node in the drainage pipe network, the fault assumption calculation by means of the hydrodynamic model can accurately locate the fault, which provides a decision-making basis for the operation and maintenance process of the drainage pipe network.

In addition to the fault detection system for a drainage pipe network described in the foregoing embodiments, embodiments of the present application further provide a fault detection method for a drainage pipe network, which will be illustrated exemplarily below.

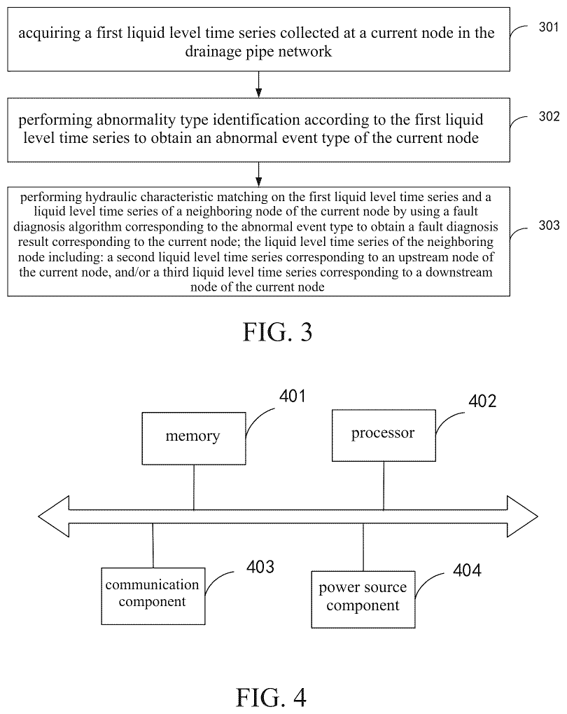

FIG. 3 is a schematic flow diagram of a method for detecting a drainage pipe network provided in an embodiment of the present application. As shown in FIG. 3, the method includes the following steps S301 to S303.

Step 301: acquiring a first liquid level time series collected at a current node in the drainage pipe network.

Step 302: performing abnormality type identification according to the first liquid level time series to obtain an abnormal event type of the current node.

Step 303: performing hydraulic characteristic matching on the first liquid level time series and a liquid level time series of a neighboring node of the current node by using a fault diagnosis algorithm corresponding to the abnormal event type to obtain a fault diagnosis result corresponding to the current node; the liquid level time series of the neighboring node including: a second liquid level time series corresponding to an upstream node of the current node, and/or a third liquid level time series corresponding to a downstream node of the current node.

In some exemplary embodiments, after obtaining the fault diagnosis result of the current node, the method further includes: performing, if the fault diagnosis result indicates that there is a fault in a pipe between the current node and the downstream node, a fault assumption calculation on the pipe between the current node and the downstream node through a hydrodynamic model of the drainage pipe network to determine a faulty pipe between the current node and the downstream node; sending information about the faulty pipe to a specified terminal device for fault prompting.

In some exemplary embodiments, a manner of performing the abnormality type identification according to the first liquid level time series to obtain the abnormal event type of the current node may include: performing inflection point detection on the first liquid level time series; determining the abnormal event type corresponding to the current node as a sudden pipe blockage type if an inflection point is detected from the first liquid level time series.

In some exemplary embodiments, a manner of performing inflection point detection on the first liquid level time series may include: dividing the first liquid level time series into a plurality of subsequences; calculating a loss function of the first liquid level time series and respective loss functions of the plurality of subsequences; calculating a signal difference between the plurality of subsequences according to a difference value between the loss function of the first liquid level time series and the respective loss functions of the plurality of subsequences; determining that there is an inflection point in the first liquid level time series if the signal difference of the subsequences is greater than a set penalty value.

In some exemplary embodiments, a manner of performing the abnormality type identification according to the first liquid level time series to obtain the abnormal event type of the current node may include: performing time series decomposition on the first liquid level time series to obtain a liquid level trend of the current node; determining the abnormal event type of the current node as a long-term blockage type if the liquid level trend of the current node presents a continuous rising trend.

In some exemplary embodiments, after determining the abnormal event type of the current node as the long-term blockage type, the method further includes: determining a blockage level corresponding to the current node according to a ratio of an amount of change in the rising trend of a liquid level of the current node to a pipe diameter.

In some exemplary embodiment, a manner of performing the abnormality type identification according to the first liquid level time series to obtain the abnormal event type of the current node may include: inputting the first liquid level time series and the third liquid level time series into a deep learning model; performing feature extraction on the first liquid level time series and the third liquid level time series based on the deep learning model; calculating, according to an extracted feature, a probability that a pipe between the current node and the downstream node belongs to at least one abnormal event type; the at least one abnormal event type including at least one of: a sudden blockage event and long-term blockage events of different levels; outputting the abnormal event type of the current node according to the probability that the pipe between the current node and the downstream node belongs to the at least one abnormal event type.

In some exemplary embodiments, before performing the feature extraction on the first liquid level time series and the third liquid level time series based on the deep learning model, the method further includes: acquiring a liquid level sequence sample marked with an abnormality type true value; the liquid level sequence sample including a plurality of sets of liquid level trend comparison data of neighboring upstream and downstream nodes; the liquid level sequence sample being acquired by monitoring liquid level data of the drainage pipe network, and/or being obtained through simulation of a hydrodynamic model of the drainage pipe network; performing feature extraction on the liquid level sequence sample through the deep learning model to obtain a sample feature; performing abnormality prediction according to the sample feature and a parameter of the deep learning model to obtain an abnormality type prediction result corresponding to the liquid level sequence sample; training the deep learning model according to an error between the abnormality type prediction result and the abnormality type true value marked on the liquid level sequence sample until the error converges to a specified range.

In some exemplary embodiments, a manner of performing the hydraulic characteristic matching on the first liquid level time series and the liquid level time series of the neighboring node of the current node by using the fault diagnosis algorithm corresponding to the abnormal event type may include: determining whether there is an inflection point in the second liquid level time series and the third liquid level time series if the abnormal event type of the current node is a sudden blockage event; determining that the fault diagnosis result corresponding to the current node is that there is a sudden blockage fault in the pipe between the current node and the downstream node, if there is no inflection point in the second liquid level time series and the third liquid level time series; comparing whether an appearance moment of the inflection point of the second liquid level time series is later than the appearance moment of the inflection point of the first liquid level time series, if there is an inflection point in the second liquid level time series and there is no inflection point in the third liquid level time series; determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

In some exemplary embodiments, a manner of performing the hydraulic characteristic matching on the first liquid level time series and the liquid level time series of the neighboring node of the current node by using the fault diagnosis algorithm corresponding to the abnormal event type may include: performing trend comparison on the first liquid level time series and the third liquid level time series if the abnormal event type of the current node is a long-term blockage event; determining that the fault diagnosis result corresponding to the current node is that there is a long-term blockage fault in the pipe between the current node and the downstream node, if a liquid level in the first liquid level time series presents a rising trend and a liquid level in the third liquid level time series has no rising trend.

In the embodiment, a liquid level time series of a monitoring node in the drainage pipe network may be collected, and an abnormal event type of the current node may be identified according to the liquid level time series. After the abnormal event type is determined, hydraulic characteristic matching may be performed on the liquid level time series of the current node and a liquid level time series corresponding to a neighboring node by using a fault diagnosis algorithm corresponding to the abnormal event type to obtain a fault diagnosis result of the current node. Based on this implementation, fault detection may be performed intelligently at a node to be monitored in a drainage pipe network, reducing reliance on manpower and facilitating efficient and accurate fault detection in the drainage pipe network, thereby assistance in the operation and maintenance of the drainage pipe network.

It should be noted that in some procedures as described in the embodiments and accompanying drawings mentioned above, a plurality of operations in a particular order are included. However, it should be clearly understood that these operations may not be executed according to the order herein or may be executed in parallel. The serial numbers, e.g., 101 and 102, of the operations are merely used to distinguish various operations, and the serial numbers themselves do not represent any executing sequences. Subjects executing respective steps of the method provided in the above embodiments may be the same device. As an alternative, different devices may also be used as subjects to execute the method. For example, subjects executing Step 301 to Step 304 may be device A. Also, for example, subjects executing Step 301 and Step 302 may be device A, and subjects executing Step 303 and Step 304 may be device B, and so forth.

In addition, these procedures may include more or fewer operations, and these operations may be executed in an order or executed in parallel. It should be noted that the descriptions of “first” and “second” herein are used to distinguish different information, devices, modules, and the like, and do not represent an order of precedence, nor do they qualify the “first” and “second” as being of different types.

FIG. 4 is a schematic structural diagram of a server provided in an embodiment of the present application. As shown in FIG. 4, the server may include: a memory 401, a processor 402, a communication component 403, and a power source component 404. Only some of the components are provided schematically in FIG. 4, and this does not mean that an electronic device only includes components shown in FIG. 4.

The memory 401 may be configured to store various other data to support operations on the server 20. Examples of these data include instructions of any application programs or methods operated on the server 20, contact data, telephone directory data, messages, pictures, videos, and so forth. The memory may be implemented by any type of volatile or nonvolatile storage device or a combination thereof, e.g., a static random-access memory (SRAM), an electrically erasable programmable read-only memory (EEPROM), a programmable read-only memory (PROM), a read-only memory (ROM), a magnetic memory, a flash memory, a magnetic disk or an optical disk.

In the embodiment, the memory 401 is used to store one or more computer instructions.

The processor 402 coupled to the memory 401 is used to execute the one or more computer instructions in the memory 401 for: through the communication component 403, acquiring a first liquid level time series collected at a current node in the drainage pipe network; performing abnormality type identification according to the first liquid level time series to obtain an abnormal event type of the current node; performing hydraulic characteristic matching on the first liquid level time series and a liquid level time series of a neighboring node of the current node by using a fault diagnosis algorithm corresponding to the abnormal event type to obtain a fault diagnosis result corresponding to the current node; the liquid level time series of the neighboring node including: a second liquid level time series corresponding to an upstream node of the current node, and/or a third liquid level time series corresponding to a downstream node of the current node.

In some implementations, after obtaining the fault diagnosis result of the current node, the processor 402 is further used for: performing, if the fault diagnosis result indicates that there is a fault in a pipe between the current node and the downstream node, a fault assumption calculation on the pipe between the current node and the downstream node through a hydrodynamic model of the drainage pipe network to determine a faulty pipe between the current node and the downstream node; sending information about the faulty pipe to a specified terminal device for fault prompting.

In some implementations, when performing the abnormality type identification according to the first liquid level time series to obtain the abnormal event type of the current node, the processor 402 is specifically used for: perform inflection point detection on the first liquid level time series; determining the abnormal event type corresponding to the current node as a sudden pipe blockage type if an inflection point is detected from the first liquid level time series.

In some implementations, when performing inflection point detection on the first liquid level time series, the processor 402 is specifically used for: dividing the first liquid level time series into a plurality of subsequences; calculating a loss function of the first liquid level time series and respective loss functions of the plurality of subsequences; calculating a signal difference between the plurality of subsequences according to a difference value between the loss function of the first liquid level time series and the respective loss functions of the plurality of subsequences; determining that there is an inflection point in the first liquid level time series if the signal difference of the subsequences is greater than a set penalty value.

In some implementations, when performing the abnormality type identification according to the first liquid level time series to obtain the abnormal event type of the current node, the processor 402 is specifically used for: performing time series decomposition on the first liquid level time series to obtain a liquid level trend of the current node; determining the abnormal event type of the current node as a long-term blockage type if the liquid level trend of the current node presents a continuous rising trend.

In some implementations, after determining the abnormal event type of the current node as the long-term blockage type, the processor 402 is further used for: determining a blockage level corresponding to the current node according to a ratio of an amount of change in the rising trend of a liquid level of the current node to a pipe diameter.

In some implementations, when performing the abnormality type identification according to the first liquid level time series to obtain the abnormal event type of the current node, the processor 402 is specifically used for: inputting the first liquid level time series and the third liquid level time series into a deep learning model; performing feature extraction on the first liquid level time series and the third liquid level time series based on the deep learning model; calculating, according to an extracted feature, a probability that a pipe between the current node and the downstream node belongs to at least one abnormal event type; the at least one abnormal event type including at least one of: a sudden blockage event and long-term blockage events of different levels; outputting the abnormal event type of the current node according to the probability that the pipe between the current node and the downstream node belongs to the at least one abnormal event type.

In some implementations, before performing the feature extraction on the first liquid level time series and the third liquid level time series based on the deep learning model, the processor 402 is further used for: acquiring a liquid level sequence sample marked with an abnormality type true value; the liquid level sequence sample including a plurality of sets of liquid level trend comparison data of neighboring upstream and downstream nodes; the liquid level sequence sample being acquired by monitoring liquid level data of the drainage pipe network, and/or being obtained through simulation of a hydrodynamic model of the drainage pipe network; performing feature extraction on the liquid level sequence sample through the deep learning model to obtain a sample feature; performing abnormality prediction according to the sample feature and a parameter of the deep learning model to obtain an abnormality type prediction result corresponding to the liquid level sequence sample; training the deep learning model according to an error between the abnormality type prediction result and the abnormality type true value marked on the liquid level sequence sample until the error converges to a specified range.

In some implementations, when performing the hydraulic characteristic matching on the first liquid level time series and the liquid level time series of the neighboring node of the current node by using the fault diagnosis algorithm corresponding to the abnormal event type, the processor 402 is specifically used for: determining whether there is an inflection point in the second liquid level time series and the third liquid level time series if the abnormal event type of the current node is a sudden blockage event; determining that the fault diagnosis result corresponding to the current node is that there is a sudden blockage fault in the pipe between the current node and the downstream node, if there is no inflection point in the second liquid level time series and the third liquid level time series; comparing whether an appearance moment of the inflection point of the second liquid level time series is later than the appearance moment of the inflection point of the first liquid level time series, if there is an inflection point in the second liquid level time series and there is no inflection point in the third liquid level time series; determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

In some implementations, when performing the hydraulic characteristic matching on the first liquid level time series and the liquid level time series of the neighboring node of the current node by using the fault diagnosis algorithm corresponding to the abnormal event type, the processor 402 is specifically used for: performing trend comparison on the first liquid level time series and the third liquid level time series if the abnormal event type of the current node is a long-term blockage event; determining that the fault diagnosis result corresponding to the current node is that there is a long-term blockage fault in the pipe between the current node and the downstream node, if a liquid level in the first liquid level time series presents a rising trend and a liquid level in the third liquid level time series has no rising trend.

The communication component 403 is configured to facilitate wired or wireless communication between a device where the communication component is located and another device. The device in which the communication component is located may access a wireless network based on a communication standard, such as WiFi, 2G, 3G, 4G, or 5G, or a combination thereof. In an exemplary embodiment, the communication component receives broadcast signals from an external broadcast management system or broadcast-related information via a broadcast channel. In an exemplary embodiment, the communication component may be implemented on the basis of a near-field communication (NFC) technology, a radio frequency identification (RFID) technology, an infrared data association (IrDA) technology, an ultrawide band (UWB) technology, a blue-tooth (BT) technology, and other technologies.

The power source component 404 provides power for various components of a device where the power source component is located. The power source component may include a power source management system, one or more power sources, and other components associated with generation, management and distribution of electric power for the device where the power source component is located.

In the embodiment, a liquid level time series at a node to be monitored in the drainage pipe network may be collected, and an abnormal event type of the current node may be identified according to the liquid level time series. After the abnormal event type is determined, hydraulic characteristic matching may be performed on the liquid level time series of the current node and a liquid level time series corresponding to an upstream node by using a fault diagnosis algorithm corresponding to the abnormal event type to obtain a fault diagnosis result of the current node. Based on the implementation manner, fault detection may be performed intelligently on a node to be monitored in the drainage pipe network, reducing reliance on manpower, and facilitating efficient and accurate fault detection of the drainage network, thereby facilitating assisting the operation and maintenance of the drainage network.

Correspondingly, the embodiments of the present application further provide a computer readable medium stored with a computer program which, when executed, can implement respective steps in the method embodiments which may be executed by a server in the method embodiments described above.

Those skilled in the art should understand that the embodiments of the present application may be provided as a method, a system or a computer program product. Accordingly, the present application may be applied in a form of entirely hardware embodiments, entirely software embodiments, or embodiments combining software and hardware aspects. Moreover, the present application may be applied in a form of computer program product implemented on one or more storage media available to computers (including but not limited to magnetic disk storages, CD-ROMs, optical memories and so forth) including program codes available to computers.

The present application is described with reference to flow diagrams and/or a block diagram of the method, device (system), and computer program product according to the embodiments of the present application. It should be understood that each flow and/or block in the flow diagrams and/or block diagram as well as a combination of a flow and/or block in the flow diagrams and/or block diagram may be implemented by computer program instructions. These computer program instructions may be provided to general-purpose computers, special-purpose computers, embedded processors or processors of other programmable data processing devices to generate a machine, such that the instructions executed by the computers or the processors of the other programmable data processing devices produce a device for carrying out the functions specified in one or more of the flows of the flowchart and/or one or more of a block or multiple blocks in the block diagram.

These computer program instructions may also be stored in a computer-readable memory capable of directing a computer or the other programmable data processing device to operate in a particular manner, such that the instructions stored in the computer-readable memory produce an article of manufacture including an instructional device that implements a function specified in one or more flows of a flow diagram and/or one or more blocks of a block diagram.

These computer program instructions may also be loaded in computers or other programmable data processing devices such that a series of operating steps are executed on the computers or other programmable devices to produce computer-implemented processing, such that the instructions executed on the computers or other programmable devices provide steps for implementing a function specified in one or more flows of a flow diagram and/or one or more blocks of a block diagram.

In a typical configuration, a computing device includes one or more processors (CPU), an input/output interface, a network interface, and a memory.

The memory may include a non-permanent memory in computer readable media, a random-access memory (RAM) and/or non-volatile memory, and other forms such as a read-only memory (ROM) or a flash memory (flash RAM). The memory is an example of computer readable media.

The computer-readable media include permanent and non-permanent, removable and non-removable media that may implement information storage with any method or technology. The information may be computer readable instructions, data structures, modules of a program or other data. Examples of computer storage media include but not limited to a phase change random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storages, a magnetic cassette tape, a magnetic tape/disk storage or other magnetic storage devices or any other non-transmission media that may be used for storing information that is accessible to a computing device. According to the definition herein, the computer readable media do not include transitory computer readable media (transitory media) such as modulated data signals and carrier waves.

It should also be noted that the terms “include” and “comprise” or any other variant thereof are intended to cover non-exclusive inclusion such that a process, method, commodity or system including a series of elements not only includes those elements, but also includes other elements not expressly listed or further includes elements that are inherent to the process, method, commodity or system. Without further limitation, an element defined by the phrase “comprising one . . . ” does not exclude the circumstance where there is still another identical element in the process, method, commodity or system including the element.

The above are only embodiments of the present application and are not intended to limit the present application. For those skilled in the art, there may be various modifications and changes in the present application. Any modifications, equivalent replacements, improvements and the like made within the spirt and principles of the present application shall be contained within the scope of the claims in the present application.

What is claimed is:

1. A fault detection method for a drainage pipe network, comprising:
acquiring a first liquid level time series collected at a current node in the drainage pipe network;
performing abnormality type identification according to the first liquid level time series to obtain an abnormal event type of the current node;
performing hydraulic characteristic matching on the first liquid level time series and a liquid level time series of a neighboring node of the current node by using a fault diagnosis algorithm corresponding to the abnormal event type to obtain a fault diagnosis result corresponding to the current node; the liquid level time series of the neighboring node comprising: a second liquid level time series corresponding to an upstream node of the current node, and/or a third liquid level time series corresponding to a downstream node of the current node.

2. The method according to claim 1, wherein after obtaining the fault diagnosis result of the current node, the method further comprises:
performing, if the fault diagnosis result indicates that there is a fault in a pipe between the current node and the downstream node, a fault assumption calculation on the pipe between the current node and the downstream node through a hydrodynamic model of the drainage pipe network to determine a faulty pipe between the current node and the downstream node;
sending information about the faulty pipe to a specified terminal device for fault prompting.

3. The method according to claim 1, wherein performing the abnormality type identification according to the first liquid level time series to obtain the abnormal event type of the current node comprises:
performing inflection point detection on the first liquid level time series;
determining the abnormal event type corresponding to the current node as a sudden pipe blockage type if an inflection point is detected from the first liquid level time series.

4. The method according to claim 3, wherein performing inflection point detection on the first liquid level time series comprises:
dividing the first liquid level time series into a plurality of subsequences;
calculating a loss function of the first liquid level time series and respective loss functions of the plurality of subsequences;
calculating a signal difference between the plurality of subsequences according to a difference value between the loss function of the first liquid level time series and the respective loss functions of the plurality of subsequences;
determining that there is an inflection point in the first liquid level time series if the signal difference of the subsequences is greater than a set penalty value.

5. The method according to claim 1, wherein performing the abnormality type identification according to the first liquid level time series to obtain the abnormal event type of the current node comprises:
performing time series decomposition on the first liquid level time series to obtain a liquid level trend of the current node;
determining the abnormal event type of the current node as a long-term blockage type if the liquid level trend of the current node presents a continuous rising trend.

6. The method according to claim 5, wherein after determining the abnormal event type of the current node as the long-term blockage type, the method further comprises:
determining a blockage level corresponding to the current node according to a ratio of an amount of change in the rising trend of a liquid level of the current node to a pipe diameter.

7. The method according to claim 1, wherein performing the abnormality type identification according to the first liquid level time series to obtain the abnormal event type of the current node comprises:
inputting the first liquid level time series and the third liquid level time series into a deep learning model;
performing feature extraction on the first liquid level time series and the third liquid level time series based on the deep learning model;
calculating, according to an extracted feature, a probability that a pipe between the current node and the downstream node belongs to at least one abnormal event type; the at least one abnormal event type comprising at least one of: a sudden blockage event and long-term blockage events of different levels;
outputting the abnormal event type of the current node according to the probability that the pipe between the current node and the downstream node belongs to the at least one abnormal event type.

8. The method according to claim 7, wherein before performing the feature extraction on the first liquid level time series and the third liquid level time series based on the deep learning model, the method further comprises:
acquiring a liquid level sequence sample marked with an abnormality type true value; the liquid level sequence sample comprising a plurality of sets of liquid level trend comparison data of neighboring upstream and downstream nodes; the liquid level sequence sample being acquired by monitoring liquid level data of the drainage pipe network, and/or being obtained through simulation of a hydrodynamic model of the drainage pipe network;
performing feature extraction on the liquid level sequence sample through the deep learning model to obtain a sample feature;
performing abnormality prediction according to the sample feature and a parameter of the deep learning model to obtain an abnormality type prediction result corresponding to the liquid level sequence sample;
training the deep learning model according to an error between the abnormality type prediction result and the abnormality type true value marked on the liquid level sequence sample until the error converges to a specified range.

9. The method according to claim 1, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

10. The method according to claim 1, wherein performing the hydraulic characteristic matching on the first liquid level time series and the liquid level time series of the neighboring node of the current node by using the fault diagnosis algorithm corresponding to the abnormal event type comprises:
performing trend comparison on the first liquid level time series and the third liquid level time series if the abnormal event type of the current node is a long-term blockage event;
determining that the fault diagnosis result corresponding to the current node is that there is a long-term blockage fault in the pipe between the current node and the downstream node if a liquid level in the first liquid level time series presents a rising trend and a liquid level in the third liquid level time series has no rising trend.

11. A server, comprising: a memory, a processor, and a communication component;
the memory being configured for storing one or more computer instructions;
the processor being configured for executing the one or more computer instructions to execute steps in the method of claim 1.

12. A non-transitory computer-readable storage medium stored with a computer program which, when executed, can implement steps in the method of claim 1.

13. The method according to claim 2, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

14. The method according to claim 3, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

15. The method according to claim 4, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

16. The method according to claim 5, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

17. The method according to claim 6, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

18. The method according to claim 7, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

19. The method according to claim 8, wherein performing the hydraulic characteristic matching on the first liquid level time series and the liquid level time series of the neighboring node of the current node by using the fault diagnosis algorithm corresponding to the abnormal event type comprises:
determining whether there is an inflection point in the second liquid level time series and the third liquid level time series if the abnormal event type of the current node is a sudden blockage event;
determining that the fault diagnosis result corresponding to the current node is that there is a sudden blockage fault in the pipe between the current node and the downstream node, if there is no inflection point in the second liquid level time series and the third liquid level time series;
comparing whether an appearance moment of the inflection point of the second liquid level time series is later than the appearance moment of the inflection point of the first liquid level time series, if there is an inflection point in the second liquid level time series and there is no inflection point in the third liquid level time series;
determining that the fault diagnosis result corresponding to the current node is that there is a sudden blockage fault in the pipe between the current node and the downstream node, if the appearance moment of the inflection point in the second liquid level time series is later than the appearance moment of the inflection point in the first liquid level time series.

20. The method according to claim 2, wherein performing the hydraulic characteristic matching on the first liquid level time series and the liquid level time series of the neighboring node of the current node by using the fault diagnosis algorithm corresponding to the abnormal event type comprises:
performing trend comparison on the first liquid level time series and the third liquid level time series if the abnormal event type of the current node is a long-term blockage event;
determining that the fault diagnosis result corresponding to the current node is that there is a long-term blockage fault in the pipe between the current node and the downstream node if a liquid level in the first liquid level time series presents a rising trend and a liquid level in the third liquid level time series has no rising trend.
